(19) United States
(12) Patent Application Publication
(10) Pub. No.: US 2014/0264207 A1
(43) Pub. Date: Sep. 18, 2014

(54) ELECTRIC ASSIST CART

(71) Applicant: KAYABA INDUSTRY CO., LTD., Minato-ku, Tokyo (JP)

(72) Inventors: Shinichi Sekine, Fukaya-shi (JP); Osamu Miyatani, Kani-shi (JP)

(21) Appl. No.: 14/350,531

(22) PCT Filed: Oct. 11, 2012
(86) PCT No.: PCT/JP2012/076314

§ 371 Date: Apr. 8, 2014

(30) Foreign Application Priority Data
Oct. 13, 2011 (JP) 2011-225981

(51) Int. Cl. B62B 5/00; B62B 3/02

(52) U.S. Cl. CPC B62B 5/0073; B62B 5/0033; B62B 3/02
USPC 254/2 C

(57) ABSTRACT

Disclosed is an electric assist cart that can travel by applying an assisting force in addition to a driving force applied by an operator. A controller operates an electric motor to apply a determined assisting force to a drive wheel and lifts or lowers a deck lift portion in response to an instruction for lifting or lowering a deck. When a handling detection part detects an instruction for braking the brake, the brake is braked, and an operation of the electric motor is inhibited regardless of a detection result of the torque detection part.

### TECHNICAL FIELD

The present invention relates to an electric assist cart in which a driving force is assisted by an electric motor.

### BACKGROUND ART

In general, when a heavy burden is loaded on a handcart used in a factory or the like, an operator necessarily pushes the handcart with a strong force at the start of delivery. This is a hard work.

As a countermeasure for this problem, JP 2006-290319 A proposes an electric assist hand-push cart in which an operator's force applied to the handcart is detected, and an assistant power corresponding to the human power is applied from an electric motor. In this electric assist hand-push cart, a force applied by an operator in forward and backward movements is assisted depending on the handling of a hand-push frame body from an operator.

### SUMMARY OF INVENTION

In the electric assist hand-push cart disclosed in JP 2006-290319 A, the electric motor is not rotated when an operator does not handle a hand-push frame body. In addition, a drive wheel connected to the electric motor serves as a brake.

The electric assist hand-push cart disclosed in JP 2006-290319 A has a mechanically actuated brake. Meanwhile, if a heavy burden is loaded on the cart, an inertial weight is large. Therefore, it is necessary to have a brake capable of operating appropriately when it is needed. That is, in order to improve safety, it is necessary to appropriately operate a brake in connection with the cart operation.

The present invention was developed in view of the above problem and aims to provide an electric assist cart capable of improving safety by appropriately operating a brake in connection with an operation state of the electric assist cart.

According to an aspect of the invention, an electric assist cart that can travel by applying an assisting force in addition to a driving force applied by an operator is provided. The electric assist car includes a body frame provided with a liftable deck where a burden can be loaded; a drive wheel provided in the body frame; an electric motor that applies an assisting force to the drive wheel; a handling portion pushed and handled by an operator to input a driving force to the body frame; a torque detection part that detects a driving force applied to the body frame by pushing and handling the handling portion; a handling detection part that detects a handling from an operator; a brake that brakes the drive wheel; a deck lift portion that lifts or lowers the deck; and a controller that controls operations of the electric motor, the brake, and the deck lift portion,

In the electric assist cart, the controller determines the assisting force depending on the driving torque detected by the torque detection part and operates the electric motor to apply the determined assisting force to the drive wheel so that, when the handling detection part detects an instruction for lifting or lowering the deck, the deck lift portion is lifted or lowered in response to the instruction, whereas, when the handling detection part detects an instruction for braking the brake, the brake is braked, and an operation of the electric motor is inhibited regardless of the detection result of the torque detection part.

The foregoing and additional features and characteristics of this disclosure will become more apparent from the following detailed description considered with the reference to the accompanying drawings.

An embodiment and advantages of the present invention are described in detail below with reference to the accompanying drawings.

### BRIEF DESCRIPTION OF DRAWINGS

FIG. 1 is a perspective view illustrating an electric assist cart according to an embodiment of the present invention;

FIG. 2 is a side view of FIG. 1 according to an embodiment of the present invention;

FIG. 3 is a front view of FIG. 1 according to an embodiment of the present invention;

FIG. 4 is a control block diagram illustrating the electric assist cart according to an embodiment of the present invention; and

FIG. 5 is a flowchart illustrating a drive operation of the electric assist cart according to an embodiment of the present invention.

### DESCRIPTION OF EMBODIMENTS

FIG. 1 is a perspective view illustrating an electric assist cart 100 according to an embodiment of the present invention. FIG. 2 is a side view illustrating the electric assist cart 100 of FIG. 1. FIG. 3 is a front view illustrating the electric assist cart 100 of FIG. 1. FIG. 4 is a control block diagram illustrating the electric assist cart 100.

The electric assist cart 100 is used to carry a heavy burden, for example, in a factory or the like. The electric assist cart 100 travels by virtue of an assisting force caused by rotation of an electric motor 15 described below in addition to a driving force applied from an operator.

In the electric assist cart 100 according to this embodiment, a forward movement direction is set to a longitudinal direction when an operator applies a driving force to a forward direction.

The electric assist cart 100 includes a body frame 1, a deck 3 provided on the body frame 1 to load a burden, a control handle 5 as a handling portion by which a driving force can be input from both left and right portions of the body frame 1, a pair of drive wheels 11 provided in both left and right sides of the body frame 1 with an interval in a travel direction, and a pair of universal wheels 12 installed in the body frame 1 in rear of the drive wheels 11. The drive wheels 11 are front wheels of the electric assist cart 100, and the universal wheels 12 are rear wheels of the electric assist cart 100.

The body frame 1 is a frame obtained by combining rectangular pipes in a rectangle. The body frame 1 includes a planar portion 1a where a burden is loaded using a deck 3, a lower projecting portion 1b projecting in the lower side of the planar portion 1a, and an erected portion 1c erected on the upper portion of the rear end of the planar portion 1a.

The deck 3 is a rimmed flat plate provided to cover the top of the planar portion 1a of the body frame 1. A burden is directly loaded on the deck 3. The deck 3 may be an unrimmed flat plate. In addition, instead of the deck 3, a roller conveyor may be installed on the body frame 1, and a burden may be loaded using the roller conveyor.

As illustrated in FIG. 2, a lift unit 2 is provided between the body frame 1 and the deck 3. This lift unit 2 includes an X-intersecting link mechanism 61 and a pair of left and right electric lift cylinders that expand or contract the link mechanism 61.

The link mechanism 61 includes X-intersecting links 62 and 63. The links 62 and 63 are connected to each other with a center pin 64, and the rear ends of the links 62 and 63 are connected to the deck 3 and the body frame 1 with the pins 65 and 66, respectively. The front ends of the links 62 and 63 are connected to the deck 3 and the body frame 1 with the slide mechanisms 67 and 68, respectively, to allow a slide in the longitudinal direction.

The electric lift cylinder 2a is connected between the link 62 and the body frame 1. As described below, the link mechanism 61 expands or contracts by expanding and contracting the electric lift cylinder 2a under control of the controller 30 so that the lift unit 2 lifts or lowers the deck 3. For example, when a heavy burden is loaded on the deck 3, and the body frame 1 sinks to the drive wheel 11 and the universal wheel 12 by means of a suspension unit 20 described below, the lift unit 2 may lift the deck 3 to constantly maintain a height of the deck 3 from the road surface.

The electric lift cylinder 2a is electrically connected to a controller 30 described below and expands or contracts in response to an instruction signal from the controller 30. The electric lift cylinder 2a, for example, is an electric hydraulic linear actuator provided with a hydraulic pump driven by a motor so as to expand or contract by a pressure of the hydraulic fluid discharged from the hydraulic pump.

As illustrated in FIG. 1, the control handle 5 is a handle handled by an operator. The control handle 5 has a reversed U-shape including a horizontal grip portion 5a handled by an operator and connecting portions 5b and 5c provided to extend vertically downward from both the left and right end portions of the grip portion 5a and connected to the erected portion 1c of the body frame 1. In this configuration, a driving force input when an operator handles the control handle 5 is transmitted to the body frame 1.

The drive wheel 11 is a small wheel unturnably provided in a longitudinal direction of the body frame 1. A pair of left and right drive wheels 11 is provided in the vicinity of the front end of the body frame 1. The drive wheels 11 are fixed to the lower projecting portion 1b of the body frame 1 movably upward and downward.

The universal wheel 12 is a small wheel directed to a movement direction at all times when the cart travels. The universal wheel 12 turns by a frictional resistance with the road surface to steer the cart toward a movement direction. The universal wheel 12 is fixed to the lower projecting portion 1b of the body frame 1 movably upward and downward.

The electric assist cart 100 includes four subsidiary frames 4 movable upward and downward against the body frame 1 and a suspension unit 20 that suspends the driving wheels 11 and the universal wheels 12 from the subsidiary frame 4.

Four subsidiary frames 4 are provided for a pair of drive wheels 11 and a pair of universal wheels 12. Two subsidiary frames 4 are arranged in each of the left and right sides of the body frame 1. The drive wheel 11 or the universal wheel 12 is rotatably fixed to the lower surface of each subsidiary frame 4.

The suspension unit 20 includes four suspension arms 22 for supporting the left and right subsidiary frames 4 of the body frame 1 movably upward and downward and spring dampers 23 provided between the body frame 1 and the left and right subsidiary frames 4.

Four suspension arms 22 are provided for a single subsidiary frame 4. Both ends of each suspension arm 22 are connected to the body frame 1 and the left and right subsidiary frames 4 pivotably around a horizontal axis, so that the suspension arm 22 serves as a parallel link mechanism that supports the subsidiary frame 4 against the body frame 1 to allow for parallel displacement.

As a result, even when the subsidiary frame 4 is lifted or lowered against the body frame 1, a posture of the subsidiary frame 4 does not change, and a positional relationship (alignment) between the drive wheel 11 and the universal wheel 12 is maintained constantly. Therefore, even when the subsidiary frame 4 is lifted or lowered, it is possible to suppress one of the drive wheel 11 and the universal wheel 12 from floating from the road surface.

The spring damper 23 absorbs or dampens vertical vibration in the drive wheel 11 and the universal wheel 12 caused by an unprepared road surface or the like and suppresses the vibration from the road surface from being transmitted to the body frame 1. The spring damper 23 has a coil spring 23a and a damper 23b. The spring damper 23 expands or contracts as the subsidiary frame 4 is lifted or lowered.

The coil spring 23a supports a load applied to the subsidiary frame 4 by virtue of its spring force. The coil spring 23a expands or contracts as the subsidiary frame 4 is lifted or lowered.

A hydraulic fluid filled in the damper 23b passes through a damping valve (not illustrated) as the coil spring 23a expands or contracts, so that the damper 23b generates a damping force for suppressing vibration of the subsidiary frame 4.

A configuration of the suspension unit 20 is not limited to that described above, but other configurations may be possible if a posture of the subsidiary frame 4 against the body frame 1 is maintained.

The electric assist cart 100 includes: a torque sensor 6 serving as a pair of torque detection parts for detecting a driving torque applied to each of the left and right portions of the body frame 1 as the control handle 5 is pushed and handled; a controller 30 that determines the assisting force applied to the drive wheel 11 depending on a driving torque detected by the torque sensor 6; a pair of electric motors 15 for applying an assisting force determined by the controller 30 to each drive wheel 11; a pair of brakes 16 that brakes rotation of each drive wheel 11; and a console 29 provided with various switches that can be manipulated by an operator.

The torque sensor 6 is electrically connected to the controller 30 and outputs an electric signal corresponding to the detected driving torque to the controller 30. The torque sensor 6 includes: a torsion bar (not illustrated) connected between the control handle 5 and the body frame 1 and twisted by the driving force input from the handling portion while the driving force is transmitted to the body frame 1; and a potentiometer (not illustrated) that outputs an electric signal corresponding to the torsion of the torsion bar. The torque sensor 6 detects the driving torque based on the torsion of the torsion bar. By changing the torsion bar provided in the torque sensor 6, it may also be possible to change a handling sense of an operator depending on a live load of the cart without changing other members.

The electric motor 15 is electrically connected to the controller 30 and is rotated depending on the electric signal input from the controller 30. As illustrated in FIG. 3, the electric motor 15 is arranged inside the drive wheel 11 to apply an assisting force to the driving wheel 11. The left and right electric motors 15 are coaxially provided and arranged in series between a pair of the drive wheels 11. The electric motor 15 may have a transmission that transmits rotation to the drive wheel 11 by decelerating the rotation.

The controller 30 has an electric current detection part 15a (refer to FIG. 4) that detects and feeds back an electric current value of the electric current flowing through the left and right electric motors 15 in practice. As a result, it is possible to perform a feedback control of the electric motor 15.

The brake 16 is arranged between an output shaft of the electric motor 15 and the drive wheel 11. The brake 16 has a brake solenoid 16a (refer to FIG. 4) that can switch between a braking state and an unbraking state. When the brake 16 switches to the braking state, the brake 16 fixes the drive wheel 11 to a rotation disable state.

The brake solenoid 16a is electrically connected to the controller 30 and switches depending on an electric current supplied from the controller 30. When an electric current flows to the brake solenoid 16a from the controller 30, the brake solenoid 16a is operated, and the brake 16 switches the drive wheel 11 to the unbraking state. Meanwhile, while no electric current flows to the brake solenoid 16a, the brake 16 maintains the drive wheel 11 in the braking state.

Specifically, the brake solenoid 16a is configured as a so-called normally closed actuator. As a result, when the controller 30 is broken down, or a cable is short-circuited, the brake 16 becomes the braking state due to the brake solenoid 16a without a failure, so that it is possible to prevent the electric assist cart 100 from rolling.

The brake solenoids 16a are provided between each of the output shafts of the left and right electric motors 15 and the drive wheel 11. A solenoid operation detector 16b for detecting an operation state of the brake solenoid 16a is provided in each of the brake solenoids 16a. The solenoid operation detector 16b detects whether or not the brake 16 has an unbraking state as an electric current flows to the brake solenoid 16a, or the brake 16 has a braking state as an electric current to the brake solenoid 16a is cut off. The detection result is output to the controller 30.

The controller 30 is mounted on the body frame 1 along with a power supply (not illustrated) or other electronic devices (not illustrated). The controller 30 performs control of the electric assist cart 100 and is a microcomputer having a central processing unit (CPU), a read-only memory (ROM), a random access memory (RAM), and an input/output (I/O) interface. The RAM stores data for the processing of the CPU, and the ROM stores a control program or the like of the CPU in advance. The I/O interface is used to input or output information from/to a connected device. Control of the electric assist cart 100 is implemented by operating the CPU or the RAM based on the program stored in the ROM.

The controller 30 is operated based on the power supplied from the power supply. When a voltage of the power supply abruptly decreases, the controller 30 stops overall control and sets the CPU to a sleep state. Assuming that a battery of 24 V is used as the power supply, the CPU is set to the sleep state, for example, when the voltage drops to, approximately, 18 V. As a result, it is possible to protect the controller 30 from an abrupt drop of the voltage of the power supply.

The controller 30 performs control such that the assisting forces for the left and right electric motors 15 are generated depending on the driving torque detected by the left and right torque sensors 6 in order to the move the electric assist cart 100 forward or backward and apply an assisting force in a straight movement, a turning movement, and a curve movement.

The controller 30 drives the electric motor 15 on a pulse width modulation (PWM) control basis. As illustrated in FIG. 4, the controller 30 has an electric current determination part 31 that determines a magnitude of the electric current flowing to the electric motor 15 and a continuous time for flowing the electric current and an electric current control part 32 that stops or restricts supply of the electric current to the electric motor 15 based on the determination of the electric current determination part 31.

The console 29 is arranged on the rear face of the erected portion 1c of the body frame 1 as illustrated in FIG. 1. The console 29 is electrically connected to the controller 30. The position of the console 29 is not particularly limited if the console 29 is provided in a position where an operator can manipulate and see it. The console 29 includes: a brake release switch 24 for switching the brake solenoid 16a to indicate a braking state of the brake 16; a deck up/down switch 25 for controlling an electric lift cylinder 2a; and an indicator 27 that indicates a state of the electric assist cart 100.

The brake release switch 24 is a switch capable of switching the brake solenoid 16a based on an operator's manipulation. As an operator manipulates the brake release switch 24, an electric current flows to the brake solenoid 16a under control of the controller 30, and the drive wheel 11 switches to an unbraking state. As a result, the electric assist cart 100 can travel.

The brake release switch 24 includes, for example, a latch type press button switch. When an operator presses the brake release switch 24, the pressed state is maintained by the latch. In this case, a signal is transmitted to the controller 30 from the brake release switch 24. The controller 30 flows an electric current to the brake solenoid 16a based on the signal from the brake release switch 24 to switch the brake 16 to the unbraking state.

When an operator presses the brake release button 24 while the brake release switch 24 is maintained in the pressed state, the latch is released so that the pressed state of the brake release switch 24 is released. In this case, a signal from the brake release switch 24 is transmitted to the controller 30. The controller 30 cuts off the electric current to the brake solenoid 16a based on the signal from the brake release switch 24 to switch the brake 16 to the braking state.

The brake release switch 24 may light up a color such as red or green depending on the pressed state of the brake release switch 24, or an indicator 27 may be used to indicate whether the brake 16 has a braking state or an unbraking state. As a result, an operator can easily and visually recognize the current control state of the brake 16.

The deck up/down switch 25 is a switch for operating the electric lift cylinder 2a based on an operator's manipulation. As an operator manipulates the deck up/down switch 25, the electric lift cylinder 2a expands or contracts. As a result, the deck 3 is lifted or lowered against the body frame 1.

The deck up/down switch 25 has, for example, a lift button and a lowering button. When an operator presses the lift button, a signal instructing the lifting is transmitted to the controller 30 from the deck up/down switch 25. The controller 30 transmits the instruction to the electric lift cylinder 2a in response to the signal from the deck up/down switch 25. In response to this instruction, the electric lift cylinder 2a expands, and the link mechanism 61 is stretched so that the deck 3 is lifted.

When an operator presses the lowering button, a signal instructing the lowering is transmitted to the controller 30 from the deck up/down switch 25. The controller 30 transmits the instruction to the electric lift cylinder 2a in response to the signal from the deck up/down switch 25. In response to this instruction, the electric lift cylinder 2a contracts, and the link mechanism 61 is retracted so that the deck 3 is lowered.

For safety purposes, control is performed such that the deck 3 is lifted or lowered only when an operator presses the deck up/down switch 25. In addition, the lifting and lowering stops when an operator releases the deck up/down switch 25. While the deck up/down switch 25 is manipulated, the deck up/down switch 25 may light up, or an indicator 27 may light up.

The indicator 27 indicates a state of the electric assist cart 100 to allow an operator to recognize it. The indicator 27 includes a light-emitting diode (LED). For example, as described below, when the manipulation performed by an operator is an unallowable instruction, the controller 30 notifies this fact by lighting up the indicator 27. This notification to an operator may be performed using sound or vibration instead of the indicator 27.

Next, a driving operation of the electric assist cart 100 will be described.

When an operator pushes the control handle 5 with both hands in parallel, the electric assist cart 100 moves forward straightly. In this case, the driving force input to the body frame 1 by pushing the control handle 5 is approximately equal between the left and right sides of the control handle 5. Therefore, the driving torques detected by left and right torque sensors 6 are also approximately equal to each other.

If the left and right torque sensors 6 detect an equal driving torque, the controller 30 instructs that the assisting force is equally applied to the left and right driving wheels 11 from the left and right electric motors 15. As a result, the assisting force is equally applied to the left and right drive wheels 11.

Therefore, the electric assist cart 100 moves forward straightly by virtue of the assisting force of the electric motor 15 in addition to the driving force applied by an operator.

When the electric assist cart 100 moves backward straightly, the pushing direction of the control handle 5 is reversed, and the driving torque detected by the torque sensor 6 has a reversed direction, compared to the forward movement. Therefore, the controller 30 reversely controls the rotation direction of the electric motor 15 in response. Other actions are similar to those of the case where the electric assist cart 100 moves forward straightly.

Meanwhile, when an operator applies the pushing force to the control handle 5 differently between the left and right sides, the electric assist cart 100 turns left or right. In this case, the assisting force is differently applied to the left and right drive wheels 11 from the left and right electric motors 15.

Specifically, for example, when the electric assist cart 100 turns left, the pushing force applied to the control handle 5 by a right hand of an operator is stronger than the pushing force applied to the control handle 5 by a left hand of an operator. Therefore, the driving torque detected by the right torque sensor 6 is higher than the driving torque detected by the left torque sensor 6.

In this case, the controller 30 instructs that the assisting force applied from the right electric motor 15 to the drive wheel 11 is stronger than the assisting force applied from the left electric motor 15 to the drive wheel 11. As a result, the assisting force applied to the right drive wheel 11 becomes relatively stronger than the assisting force applied to the left drive wheel 11.

The magnitude of the assisting force can be controlled depending on the pushing force applied by an operator to the control handle 5 because the left and right torque sensors 6 can detect the driving force steplessly.

Next, a relationship with the driving operation of the brake 16 of the electric assist cart 100 will be described.

FIG. 5 is a flowchart illustrating a driving operation according to an embodiment of the present invention.

The flowchart of FIG. 5 is initiated and executed by the controller 30 when the operation of the electric assist cart 100 starts. For example, when an operator manipulates a control button provided on the console 29 to start the operation of the electric assist cart 100, the operation of the flowchart is initiated.

First, the controller 30 determines whether or not the brake 16 has a braking state (step S11).

The controller 30 determines whether the brake 16 is controlled to the braking state or the unbraking state depending on the state of the brake release switch 25 manipulated by an operator. Specifically, the controller 30 determines whether the brake 16 is in the braking state or the unbraking state by detecting an operation state of the brake solenoid 16a based on the signal output from the solenoid operation detector 16b. Whether the brake 16 is in the braking state or the unbraking state may be determined based on whether or not the controller 30 supplies an electric current to the brake solenoid 16a without depending on the signal output from the solenoid operation detector 16b.

If it is determined that the brake 16 has the braking state, the process advances to step S12. If it is determined that the brake 16 has the unbraking state, the process advances to step S22.

If it is determined that the brake 16 has the braking state, the controller 30 inhibits the electric motor 15 from applying the assisting force (step S12).

Specifically, when the application of the assisting force is inhibited, the controller 30 inhibits the operation of the electric motor 15 regardless of whether or not the driving torque is detected by the torque sensor 6. Due to this control, the electric motor 15 is not driven, and the application of the assisting force is inhibited even when an operator manipulates the control handle 5.

Therefore, if the brake 16 has the braking state, the electric assist cart 100 does not move forward or backward due to the braking force of the brake 16 even when an operator manipulates the control handle 5.

Next, the controller 30 determines whether or not the deck up/down switch 25 is manipulated (step S13).

If it is determined that an operator manipulates the deck up/down switch 25, and a signal for instructing the lifting or lowering is transmitted from the deck up/down switch 25, the controller 30 advances to step S14 and outputs an instruction to the electric lift cylinder 2a based on the instruction from the deck up/down switch 25. As the electric lift cylinder 2a expands or contracts based on this instruction, the link mechanism 61 is stretched or retracted so that the deck 3 is lifted or lowered against the body frame 1. After the processing of step S14, the process returns to step S11.

If the deck up/down switch 25 is not manipulated, the process returns to step S11 without performing the processing of step S14.

If it is determined that the brake 16 has the unbraking state in step S11, the controller 30 inhibits the lifting or lowering operation of the deck 3 (step S22).

Specifically, if the lifting or lowering of the deck 3 is inhibited, the controller 30 restricts the operation of the electric lift cylinder 2a to prohibit the deck 3 from being lifted or lowered regardless of whether or not the manipulation of the deck up/down switch 25 is detected. As a result, the electric lift cylinder 2a is not driven, and the deck 3 is not lifted or lowered even when an operator manipulates the deck up/down switch 25.

Then, the controller 30 determines whether or not the driving torque is detected by the torque sensor 6 (step S23).

If the driving torque is detected by the torque sensor 6, the controller 30 controls the operation of the electric motor 15 depending on the detected driving torque as described above to apply the assisting force to the forward or backward movement of the electric assist cart 100 (step S24). After the processing of step S24, the process returns to step S11.

If the driving torque is not detected, the process returns to step S11 without processing step S24.

As illustrated in the flowchart of FIG. 5, when the brake 16 has the braking state, the controller 30 inhibits application of the assisting force and allows only for the lifting or lowering operation of the deck 3. Meanwhile, when the brake 16 has the unbraking state, the lifting or lowering operation of the deck 3 is inhibited, and only the application of the assisting force is allowed.

In the flowchart of FIG. 5, steps S11 to S24 are sequentially and repeatedly executed. For example, if an operator manipulates the brake release switch 24 to instruct the unbraking of the brake 16 in step S11 immediately after the electric lift cylinder 2a is operated in step S14, the process advances to step S22 so that the lifting or lowering operation of the deck 3 is inhibited, and the operation of the electric lift cylinder 2a stops. In this case, the operation of the electric lift cylinder 2a does not immediately stop in response to the manipulation of the brake release switch 24, but the operation may stop smoothly.

Similarly, if an operator manipulates the brake release switch 24 to instruct the braking of the brake 16 in step S11 immediately after the assisting force is applied by operating the electric motor 15 in step S24, the process advances to step S12 so that the operation of applying the assisting force is inhibited, and the operation of the electric motor 15 stops. In this case, the operation of the electric motor 15 does not immediately stop in response to the manipulation of the brake release switch 24, but the operation may stop smoothly.

Similarly, in the switching between the braking and the unbraking of the brake 16, the brake solenoid 16a may be operated smoothly in order to prevent an abrupt stop of the electric assist cart 100 during the traveling.

As described above, according to the embodiment of the present invention, in the electric assist cart 100, a driving force of an operator is detected by the torque sensor 6, and the assisting force corresponding to the detected driving force is applied by the electric motor 15. The electric assist cart 100 includes the deck up/down switch 25 that instructs a lifting or lowering operation of the lift unit 2 for lifting or lowering the deck 3 based on a manipulation of an operator, and a brake release switch 24 that instructs the braking state of the brake 16 based on a manipulation of an operator.

In such an electric assist cart 100, if the electric motor 15 is driven while the brake release switch 24 is not pressed, and the brake 16 has the braking state, the electric motor 15 is not rotated, and the supplied electric current is totally converted into heat. For this reason, the electric current flowing to the electric motor 15 may become wasteful, and electric power from the mounted battery or the like may be uselessly consumed. In addition, the electric motor 15 or the controller 30 may be damaged due to the heat.

In this regard, if the brake 16 has the braking state, the application of the assisting force from the electric motor 15 is inhibited regardless of whether or not the torque sensor 6 detects the driving force generated when an operator handles the control handle 5. As a result, supply of the electric current to the electric motor 15 is inhibited while the brake 16 has the braking state. Therefore, it is possible to avoid the electric motor 15 from uselessly consuming electric power and prevent a failure of the electric motor 15, the controller 30, and the like beforehand.

If the brake release switch 24 is pressed, and the brake 16 has the unbraking state, the drive wheel 11 of the electric assist cart 100 is not locked. Therefore, the electric assist cart 100 may travel free regardless of the handling of the control handle 5. When the deck 3 is lifted or lowered by manipulating the deck up/down switch 25 in this state, the electric assist cart 100 may travel free as a center position changes due to the lifting or the lowering of the deck 3 or the like, so that a burden loaded on the deck 3 may fall down.

In this regard, when the brake 16 has the unbraking state, the lifting or lowering operation of the deck 3 is inhibited regardless of whether or not the deck up/down switch 25 is manipulated by an operator. As a result, the operation of the electric lift cylinder 2a is inhibited while the brake 16 has the unbraking state. In addition, it is possible to prevent the electric assist cart 100 from carelessly traveling free beforehand as the deck 3 is lifted or lowered.

Therefore, according to the embodiment of the present invention, it is possible to improve safety and reliability of the electric assist cart 100.

An indicator such as an LED whose lighting state changes depending on the pressed state of the brake release switch 24 may be embedded in the brake release switch 24 to indicate whether the brake 16 has the braking state or the unbraking state. As a result, an operator can easily and visually recognizes the current control state of the brake 16 and prepare a countermeasure in advance. For example, it is possible to prevent an operator from carelessly pushing the electric assist cart 100.

While the embodiments of the present invention have been described hereinbefore, it would be appreciated that they are just for illustrative purposes and are not intended to limit a technical scope of the present invention to such a specific configuration.

This application is based on and claims priority to Japanese Patent Application Laid-open No. 2011-225981 (filed in Japan Patent Office on Oct. 13, 2011), the entire content of which is incorporated herein by reference.

Exclusive characteristics or properties encompassing the examples of the present invention are incorporated in the following claims.

1. An electric assist cart that can travel by applying an assisting force in addition to a driving force applied by an operator, comprising:
a body frame provided with a liftable deck where a burden can be loaded;
a drive wheel provided in the body frame;
an electric motor that configured to apply an assisting force to the drive wheel;
a handling portion pushed and handled by an operator to input a driving force to the body frame;
a torque detection part that configured to detect a driving force applied to the body frame by pushing and handling the handling portion;
a handling detection part that configured to detect a handling from an operator;
a brake that brakes the drive wheel;
a deck lift portion that lifts or lowers the deck; and
a controller that configured to control operations of the electric motor, the brake, and the deck lift portion,
wherein the controller determines the assisting force depending on the driving torque detected by the torque detection part and operates the electric motor to apply the determined assisting force to the drive wheel so that, when the handling detection part detects an instruction for lifting or lowering the deck, the deck lift portion is lifted or lowered in response to the instruction, whereas, when the handling detection part detects an instruction for braking the brake, the brake is braked, and an operation of the electric motor is inhibited regardless of the detection result of the torque detection part.

2. The electric assist cart according to claim 1, wherein the controller release braking of the brake and inhibits a lifting or lowering operation of the deck lift portion regardless of a detection result of the handling detection part when the handling detection part detects a release of the braking of the brake.
